(19) United States
(12) Patent Application Publication
(10) Pub. No.: US 2017/0124762 A1
(43) Pub. Date: May 4, 2017

(54) VIRTUAL REALITY METHOD AND SYSTEM FOR TEXT MANIPULATION

(71) Applicant: Xerox Corporation, Norwalk, CT (US)

(72) Inventors: Caroline Privault, Montbonnot-Saint-Martin (FR); Fabien Guillot, Vaulnaveys-le-Haut (FR); Christophe Legras, Montbonnot-Saint-Martin (FR); Ioan Calapodescu, Grenoble (FR)

(73) Assignee: Xerox Corporation, Norwalk, CT (US)

(21) Appl. No.: 14/925,384

(22) Filed: Oct. 28, 2015

(51) Int. Cl. G06T 19/00; G06F 3/01; G06F 17/21; G06F 3/0482; G06F 3/0481; G06F 17/24; G06T 19/20; G06F 3/0484

(52) U.S. Cl. CPC G06T 19/006; G06T 19/20; G06F 3/017; G06F 3/04842; G06F 3/0482; G06F 3/012; G06F 3/04815; G06F 17/24; G06F 17/212

(57) ABSTRACT

A Virtual Reality (VR) method and system for text manipulation. According to an exemplary embodiment, a VR method displays and provides a user with interaction with displayed documents in a Virtual Environment (VE), the VE including a VR head-mounted display and one or more gesture sensors. Text manipulation is performed using natural human body interactions with the VR system.

### BACKGROUND

This disclosure relates to a Virtual Reality (VR) method and system for text manipulation. According to an exemplary embodiment, a VR method displays and provides a user with interaction with displayed documents in a Virtual Environment (VE), the VE including a VR head-mounted display, and one or more gesture sensors.

Below is provided summaries of some of the prior art related to VR as it is applied to text.

“Screen: bodily interaction with text in immersive VR”. 2003. J. J Carroll, R. Coover, S. Greenlee, A. McClain, N. Wardrip-Fruin. In Proceedings of SIGGRAPH '03 ACM Sketches & Applications. This disclosure relates to artworks. It presents a system using a virtual reality environment (“Brown University Cave”) where a user can read a text and interact with her body. Interaction is provided through specific gloves, and the user cannot directly interact with the text. Instead, pieces of text “come to” the user, where a word peels from one of the walls and flies toward the reader. The user interaction is limited to striking words. The reader can intervene in this process by striking words with her hand which is tracked with either a glove or wand. This body-involved process—of reading the words that fly at the reader, of reading the flock of words around the reader, of reading individual words while striking them with your hand—is the second stage of reading.

“SEE MORE: Improving the Usage of Large Display Environments”. 2008. A. Ebert, H. Hagen, T. Bierz, M. Deller, P. S. Olech, D. Steffen, S. Thelen. In Proceedings of Dagstuhl Workshop on Virtual Reality, 2008. This disclosure provides a single wall/screen for visualization of several documents at the same time with links to other documents, emphasizing the degree of similarity between documents. The system uses a 3-Dimensional stereoscopic projection screen where a central document is projected and the context of the document is provided as a cloud of small icons designating other documents having similarities with the central document. It is not disclosed that the user can directly interact with the text through gesture. The disclosure provides “the user can enter several queries resulting in the change of relevance of the single documents”. The focus of this disclosure is more on how to enhance the quality of the projection and reading for users: e.g., transition from the 3D context view to a 2D focus view.

“A large 2d+3d focus+context screen”. 2008. Achim Ebert, P. Dannenmann, M. Deller, D. Steffen, N. D. Gershon. In Proceedings of the 2008 Conference on Human Factors in Computing Systems, 2008 CHI Extended Abstracts, p 2691-2696, Florence, Italy, April 5-10. This disclosure describes a system where immersion is provided through the usage of large displays. The disclosure claims it provides an “immersive effect” which is made stronger by the use of a stereoscopic representation of information.

Mechdyne CAVE™: http://www.mechdyne.com/immersive.aspx. The Mechdyne CAVE™ virtual reality system is described as “a room-sized, advanced visualization solution that combines high-resolution, stereoscopic projection and 3D computer graphics to create a complete sense of presence in a virtual environment”. Interactions are made through head movement tracking and control pads or wands, so there is no natural body gesture interaction. “CAVEs” are demanding on projection and video processing where computers with many graphic cards or more commonly a rack containing multiple computers are required.

### INCORPORATION BY REFERENCE

CARROLL et al., “Screen: Bodily Interaction with Text in Immersive VR”, in proceedings of SIGGRAPH '03 ACM Sketches & Applications, 2003, 1 page;

PENNY et al., “Traces: Wireless full body tracking in the CAVE”, In Ninth International Conference on Artificial Reality and Telexistence (ICAT99), 1999, 9 pages;

UTTERBACK, “Unusual Positions—embodied interaction with symbolic spaces”, In First Person, MIT Press, 2003, 9 pages;

SMALL et al., “An Interactive Poetic Garden”, In Extended Abstracts of CHI'98, 1 page;

“Enter the CAVE”, Tech Tips, www.inavateonthenet.net, March, 2012, 1 page;

http://www.microsoft.com/en-us/kinectforwindows/meetkinect, “Microsoft Kinect”;

“LeapMotion Controller”, https://www.leapmotion.com/product;

“Oculus Rift”, http://www.oculus.com/rift/;

“Oculus Rift in the classroom: Immersive education's next level”, http://www.zdnet.com/oculus-rift-in-the-classroom-immersive-educations-next-level-7000034099/;

EBERT et al., “SEE MORE: Improving the Usage of Large Display Environments”, in Proceedings of Dagstuhl Workshop on Virtual Reality, 2008, pages 161-180;

“A Large 2D+3D Focus+Context Screen”, CHI 2008 Proceedings, Works in Progress, Apr. 5-10, 2008, Florence, Italy;

Inavate, “CAVE VR tool dissected”, May 7, 2012, 6 pages;

http://www.mechdyne.com/hardware.aspx, Mechdyne, Immersive, CAVE™, are incorporated herein by reference in their entirety.

### BRIEF DESCRIPTION

In one embodiment of this disclosure, described is a computer-implemented method of displaying and directly interacting with documents and associated textual content in a Virtual Environment (VE), the VE including a Virtual Reality (VR) head-mounted display, one or more operatively associated gesture sensors and one or more operatively associated controllers, the method comprising: the VR head-mounted display displaying a rendering of a document in a first vertical pane and displaying a second vertical pane, the document including textual objects displayed on the first vertical pane and one or more other objects associated with the textual objects which are not displayed on the first vertical pane; and the one or more controllers processing data received from the one or more gesture sensors associated with selecting a textual object displayed on the first vertical pane, and the controller processing the selected textual object to display on the second vertical pane associated with the VR head-mounted display, the one or more objects associated with the selected textual object.

In another embodiment of this disclosure, described is a document processing system for displaying and directly interacting with documents and associated textual content in a Virtual Environment (VE), the document processing system comprising: a Virtual Reality (VR) head-mounted display configured to display a virtual rendering of a document including a first vertical pane and a second vertical pane; one or more operatively associated body gesture sensors; one or more operatively associated controllers, the one or more controllers configured to: generate a model of the virtual rendering of the document and communicate the model to the VR head-mounted display for viewing by a user, the model including the first vertical pane and the second vertical pane, and the document including textual objects displayed on the first vertical pane and one or more other objects associated with the textual objects which are not displayed on the first vertical pane; and process data received from the one or more gesture sensors selecting a textual object display on the first vertical pane to display on the second vertical pane the objects associated with the selected textual object.

In still another embodiment of this disclosure, described is a document processing system for displaying and directly interacting with documents and associated textual content in a Virtual Environment (VE), the document processing system comprising: a Virtual Reality (VR) head-mounted display and tracker configured to display a virtual rendering of a document including textual objects and one or more other objects including a first vertical pane, a second vertical pane and a third vertical pane, and the VR head-mounted display configured to track a user's head movements; a body gesture sensor; a hand and finger motion sensor; a model transformation module configured to operatively receive gesture data from the VR head-mounted display, body gesture sensor and hand and finger motion sensor, and the model transformation module configured to process the received gesture data and generate model transformations formatted to be communicated to a VE (Virtual Environment) rendering module; and the VE rendering module configured to receive the model transformation, generate an active VR model associated with active scenes to be rendered by the VR head-mounted display, and communicating the active scenes to the VR head-mounted display for rendering, the active scenes including an active first vertical pane, a second vertical pane and a third vertical pane.

### BRIEF DESCRIPTION OF THE DRAWINGS

FIG. 1 is a global scene of a Virtual Environment according to an exemplary embodiment of this disclosure, the global scene including a central pane, a left pane and a right pane.

FIG. 2 is a block diagram of a document processing system for displaying and directly interacting with documents and associated textual context in a Virtual Environment (VE), according to an exemplary embodiment of this disclosure.

FIG. 3 is a block diagram of the Input Processing Component shown in FIG. 2 associated with an exemplary example of a user interacting with a displayed document using a pointing gesture, where the user stretches their arm towards a displayed central text pane and the user points their arm to specific text to designate a text token.

FIG. 4 is a block diagram of the Input Processing Component shown in FIG. 2 associated with another exemplary example of a user interacting with a displayed document using a scrolling gesture, where the user stretches their arm towards the central text pane and moves it vertically towards a text pane to scroll up/down the text for reading page by page.

### DETAILED DESCRIPTION

This disclosure provides a fully immersive environment to manipulate text elements and to augment reading through an immersive visualization and interacting environment. According to an exemplary embodiment, it includes three virtual panes: one virtual pane for text which can be manipulated by text adapted 3D gestures provided by a user and visual manipulation feedback including text scroll, zoom, text selection, paragraph collapse; one virtual pane for text grabbed, i.e., selected, by a user which allows free 3D placement and association of text elements; and one virtual pane for augmented reading. The interactive environment system includes immersive glasses for the visual part, and body and hand trackers for gesture recognition and direct manipulation. Some applications of the disclosed embodiments include a learning domain, especially where students touch text to learn reading or concepts more easily, and other applications where physical text manipulation and augmented reading makes sense such as document screening. In addition, the disclosure is relevant in the domain of education for which the immersion and touch interface provides a learning platform which is more engaging for students and enables students to focus and concentrate. Other applications include physical text manipulation where augmented reading makes sense such as document screening, e.g., in health care, as well as foreign language acquisition where the pronunciation of words and phrases is provided.

Specifically, disclosed is a system that provides a virtual environment 102 (VE) for interacting with documents and their textual content directly by gesturing. The VE is there to provide an immersive experience to a user who can interact with the environment through natural body and hand gestures. “Immersive learning” is only one example of an application of this system.

Immersion in virtual reality has a broad field of application. Typical applications are in the gaming industry, but also in security, manufacturing or healthcare. The method and system described herein including, but not limited to, text manipulation and more specifically, the applications of text manipulation include: foreign language acquisition (eLearning), early reading and writing (Education), and fast screening of documents by analysts, for example legal documents, etc.

VR can make eLearning applications more engaging and interactive, providing also a collaborative experience.

According to an exemplary embodiment, a virtual environment (VE) system is provided for interacting with documents and their textual contents directly by gesturing. The VE system providing an immersive experience to the user who interacts with text contents through natural body and hand gestures. The VE system includes a combination of gesture sensors allowing the user to interact with the VE, the gesture sensors including a body gesture sensor, an optional hand and finger motion sensor and a virtual reality head-mounted display.

A 3D (3 Dimensional) model of the VE displays three panes including a central pane, a left pane and a right pane. The 3D model enables the user to read a text as displayed on the central plane; zoom in/out; select items of text; move selected items to store them; get media and/or metadata information on the selected items; edit the document textual contents by removing selected items; tag the document, e.g., positive/negative or using any other category system and store all item selections and possible changes in text and associated information input by the user (e.g., document tag) at the end of the session. The 3D model can modify the VE rendering upon information extracted automatically from the document text contents, these changes in VE rendering includes modifications of the ambient luminosity, color of the panes, etc., based upon automatic extraction of mood or emotion or opinion or sentiment or topic category from the text, and through techniques known as “Sentiment Analysis” in Text Mining, or through text classification technologies.

### Description of Virtual Environment

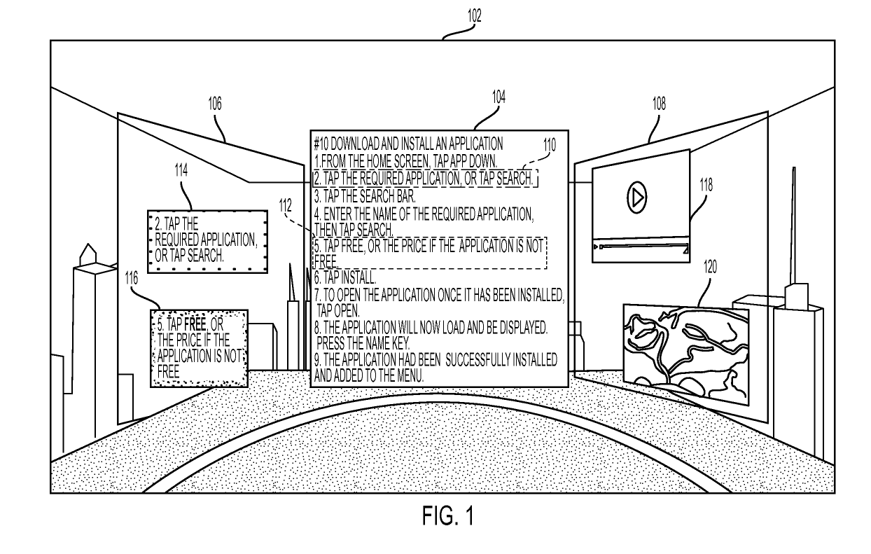

With reference to FIG. 1, shown is a global scene of a Virtual Environment 102 according to an exemplary embodiment of this disclosure, the global scene including a central pane 104, a left pane 106 and a right pane 108.

The VE 102 renders a view of a room containing the 3 vertical panes, where the central pane 104 and two side panes 106 and 108 are aligned at approximately 45° from the orientation of the central pane 104. The user stands or sits in front of the central pane 104 which offers a reading view of a document, showing the text in a readable scale.

The central pane 104 is essentially for reading a document by scrolling up/down, but it also allows the user to perform some selections of text directly as reference characters 110 and 112 indicate, and perform operations such as data extraction, or optionally to remove some parts of the document to perform text condensation. The central pane 104 can be moved backward/forward in order to adjust the scale.

The pane to the right 108 is configured to display media or metadata information pre-associated with some segments of the text, word, phrases entities, etc. After segments are selected by the user from the central pane 104, the right pane 108 displays videos, images, audio files, and/or text meta-data, etc., that can be further activated or discarded. For example, video 118 and image 120 shown in FIG. 1 right pane are associated with the document displayed in the central pane 104. Alternatively, the 3rd pane, i.e., right pane 108, can be omitted and the multimedia content associated with respective textual element is played or displayed on the whole surface of the right wall of the virtual room.

As part of the media data associated with text fragments that the user might want to display on their right within the Virtual Environment, 3D models can be included. Examples include 3D computer graphics program files such as 3DS Max and Maya files. The 3D models will be rendered in the VE to the right side of the user.

Additionally, when the user points with his/her arm to a displayed 3D model, a timer module will count how long the user keeps pointing with his/her arm towards the rendered 3D model. Above a predefined time-threshold, the system detects that the user wants to explore the inside of the 3D model. Consequently the system modifies the VE, by immersing the user into the 3D object. It renders a virtual model of the interior of the object that the user can further explore by moving his head and body. For example, if a 3D model of a car was displayed to the right of the user, pointing for a certain time to the rendered 3D object will cause the user to be immersed in a virtual model of the interior of the car; turning his/her head to the back, the user will see the back-seats of the car, and so on. The user quits the 3D model by a predefined gesture, and finds himself/herself back into the usual main environment of the system.

The pane to the left 106 is configured to receive different and successive segments selected by the user from the document on the central pane, for example, text segment 110 corresponds to text segment 114 displayed on the left pane 106, and text segment 112 corresponds to text segment 116 displayed on the left pane 106. The left pane is used to gather key concepts, information, data that are found useful to the user in the course of the user's reading.

### System Architecture and Devices

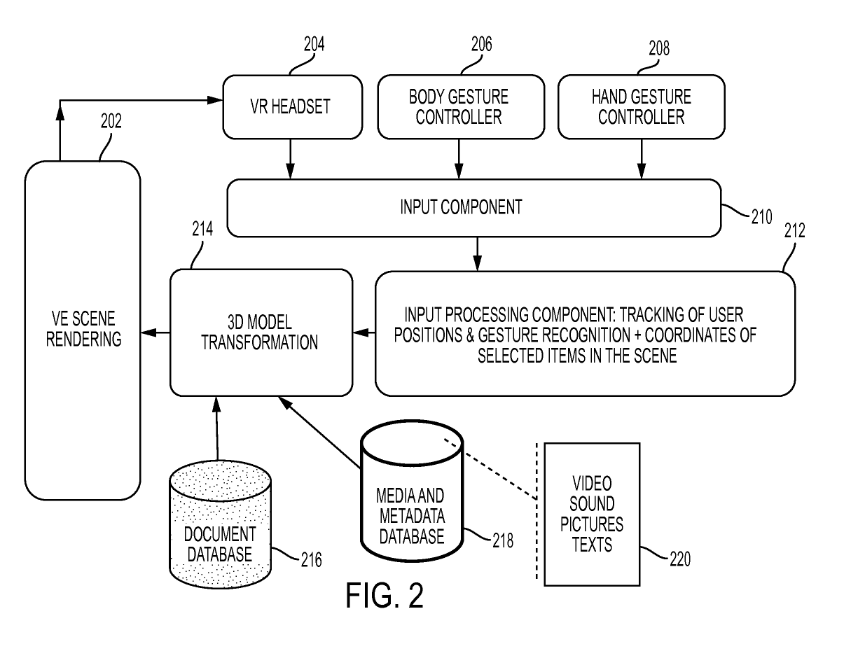

With reference to FIG. 2, shown is a block diagram of a document processing system for displaying and directly interacting with documents and associated textual context in a Virtual Environment (VE), according to an exemplary embodiment of this disclosure.

The document processing system disclosed renders the VE as previously described with reference to FIG. 1, captures the user's natural body gestures and reacts upon the user's actions. To this end the system includes the following specific hardware devices:

A body gesture sensor and operatively associated controller 206 captures the user's full body gestures, i.e., arms, legs, etc., and tracks their positions and movements in the 3D environment, e.g., Microsoft Kinect®. See http://www.microsoft.com/en-us/kinectforwindows/meetkinect;

An optional hand and finger motion-sensor and operatively associated controller 208 tracks the user's hands and fingers movements and positions, e.g., LeapMotion® controller. See https://www.leapmotion.com/product; and

A Virtual Reality head-mounted display and operatively associated VR Headset 204 provides 360° tracking of the user's head movements and creates a stereoscopic 3D view of the VE, e.g., Oculus Rift. See http://www.oculus.com/rift/. In addition, this device can optionally provide some sound.

### Input Component. 210

The input component receives data from the body, hand and finger motion controllers, 206 and 208 respectively, and from the VR headset 204. The data collected from the motion events and received in the input component 210 is transferred to an input processing component 212.

### Input Processing Component. 212

The input processing component 212 receives data from each of the 3D motion controllers 204, 206 and 208. Each input provides the system with different types of data formatted respectively, which are interpreted by the input processing component 212 to provide input information such as a gesture, some positions in the scene, pointed elements and/or commands triggered by the user.

3D Model Transformation. 214

The 3D model component 214 receives a recognized gesture and the associated information including coordinates of text, selected items, etc., from the input processing component 212 to calculate corresponding model transformations. Transformations are formatted to be passed to the VE rendering module.

### VE Scene Rendering 202

The VE rendering subsystem 202 is configured to retrieve data from the 3D model transformation 214 processing component, i.e., user's position, coordinates of elements pointed to within the text, etc., together with user actions detected by an action processing server, and model this information in virtual reality. The VE rendering subsystem 202 renders the scenes in the VE, i.e., VR headset performs the requested modifications, and provides feedback to the user.

### Document Database 216

The document database is pre-populated with a defined set of documents, prioritized or set in a random order. After a session starts, a user automatically views the first document open on the central pane 104.

### Media and Metadata Database 218

The media and metadata database 218 is pre-populated with media 220 or metadata information already associated with one or more words or text segments in each document, e.g., audio files, videos, pictures, and text.

### Functions

To operate the system, a user wears a VR headset, and stands or sits in the range of body/gesture sensors, which are operatively connected to the VR headset 204, body gesture controller 206 and hand gesture controller 208, respectively. Viewable by the user are two or three panes: a central pane, and on each side at approximately 45° a second/third pane. Within this environment, the following actions and gestures are tracked and recognized.

Read text through vertical scroll: the user can move text up or down with both hands open, palms directed towards the central pane moving together vertically over the central pane to scroll through the pages, providing a contactless gesture. Notably this is a 2-hand gesture to discriminate with a selection gesture described below. Alternatively, the user can point and select a zone or widget on the text (or on the side of the text) with their hand, and then scroll the text by moving that selected widget upward or downward using a one handed gesture.

Move central pane forward/backward: the user can zoom in or out by bringing closer to the user the central pane in order to facilitate reading or text selection. Again, this is a 2-hand gesture where after a simultaneous grasp, i.e., closing fist, of each hand in front of the chest, the user moves simultaneously both fists forward or backward, as if they could hold the vertical borders of the central pane to make it slide on the floor.

### Select Contents

To select a word, the user projects their hand in the direction of the targeted item in the text, palm directed towards the central pane. The system reacts by providing feedback on the word currently pointed to by the user according to feedback from the gesture sensor, where feedback is provided through character highlighting, and/or color change and/or word moving forward/backward from text, etc. After the user desired item is recognized, the user confirms their choice through a grasping gesture, i.e. closing one's fist.

To select a phrase, the user selects the word at the beginning of the desired phrase through the gesture described above. In a similar fashion, the user also selects a second word delimitating the end of the phrase or section. After the second confirmation grasp gesture is captured by the system, the whole phrase or section is highlighted to the user, i.e., character highlighting, color change, section moving forward/backward from text, etc.

To extend a selection, the user selected text is extended through a new word selection where it extends the current selection backward if the new word is before the previous selection, or forward if the new word is after the previous selection.

Undo selection/Unselect cancels an item selection where a vertical swipe is used. The vertical swipe is a quick vertical gesture from one hand swiping the air palm-down towards the floor, thereby throwing away the last selection and removing the highlighting or any previous change in text. Alternatively, any selected item can be dragged through hand gesture to a “cancellation zone” (on one of the text panes, or close to the text panes): when the item reaches that zone, the corresponding texts selection is cancelled.

Move Selected Contents: moves selected text to the left pane by a swipe-to-the-left gesture or drag gesture from user's arm, i.e., single-hand gesture. After an item is dragged to the left pane, its highlighting on the central pane vanishes to prepare for the next user selection. Optionally, the user can further organize the items on the left pane by grouping them manually into clusters.

The left pane progressively accumulates/stores all the words, phrases and useful information extracted by the user from the document through his reading.

Remove Selected Contents: removes from the document itself a selected word, phrase or section by a “closing gesture”, i.e., the user moving their hands with 2 palms facing each other, until palms are in contact. This function provides progressively performing document redaction or text condensation.

Get Media Information On Selected Text: when a text item is selected by a user on the central pane, the system automatically displays text pre-associated media data or meta-data on the right pane, if any multimedia information is pre-associated with the selected text segments. Information is displayed on the right pane through icons that the user can further activate through the same select-confirm gesture as described above. A change in the visual aspect of the borders of the right pane occurs to draw a user's attention. Optionally, the system can give some indication “in-line” on whether a text segment has some associated media or metadata info or not. Alternatively, all multimedia contents pre-associated with a text segment can be displayed on the whole space right of the user, or all around the user, without being restricted to the boundaries of a third pane.

Example #1: a selected word has an associated audio pronunciation file, for instance in MP3 format, where an icon of the file appears on the right pane upon text selection. On the right pane, a select-confirm gesture performed by the user on the icon plays the sound.

Example #2: a selected word has an associated movie or 3D model or picture file, for instance in AVI format for the video, or 3DS format for the 3D model or JPEG for the image. The icon of the AVI file appears on the right pane upon text selection gesture and a select-confirm gesture on the icon in the right pane plays the video, i.e., images are displayed directly.

Example #3: a selected word has a pre-associated dictionary entry in the database which is displayed on the right pane upon a user's selection on the central pane.

VE Change According To Text Contents: it modifies automatically the rendering of the virtual environment, e.g., ambient light, sound, directional light, color changes of the floor, wall, etc., depending on information automatically extracted from the textual contents of the document, e.g., mood sensing from the text, sentiment analysis, positive/negative opinion in text.

Control Tablet: it provides the user with control of a few actions beyond the virtual environment. These actions are performed via a virtual control device which is a 3D graphic artefact floating in the air. To see the control tablet, the user must tilt their head downwards; in this way the tablet does not interfere with the field of view of the user during his reading or selection. According to an exemplary embodiment, the control device displays three buttons:

Save User's Work, which automatically saves the user's work, by aggregating the left pane's content, i.e., text selections and optional manual clustering of the selected items by the user, and the changes that the user made to the document on the central pane, e.g., through text redaction or condensation.

Next Document, where the user can ask for a new document to be displayed on the central pane. First, the system automatically saves the previous user's work. Then, the system automatically pulls out a new document from the data base and displays it on the central pane. The document is either randomly selected, or will be the next document according to a predefined order, or will be selected based on high similarity or dissimilarity with the current document.

Exit application, where the user quits the application. This function first saves the user's work, as described above, and in addition it also stores the full state of the virtual environment, so that it can be re-instantiated later when the user re-launches the application and wants to continue their previous reading.

Starting Session pre-populates the database with a defined set of documents, prioritized or set in a random order. After the session starts the user automatically views the first document open on the central pane.

Calibration: before starting the session. The user enters a calibration stage where she learns how to practice the basic gestures recognized by the system.

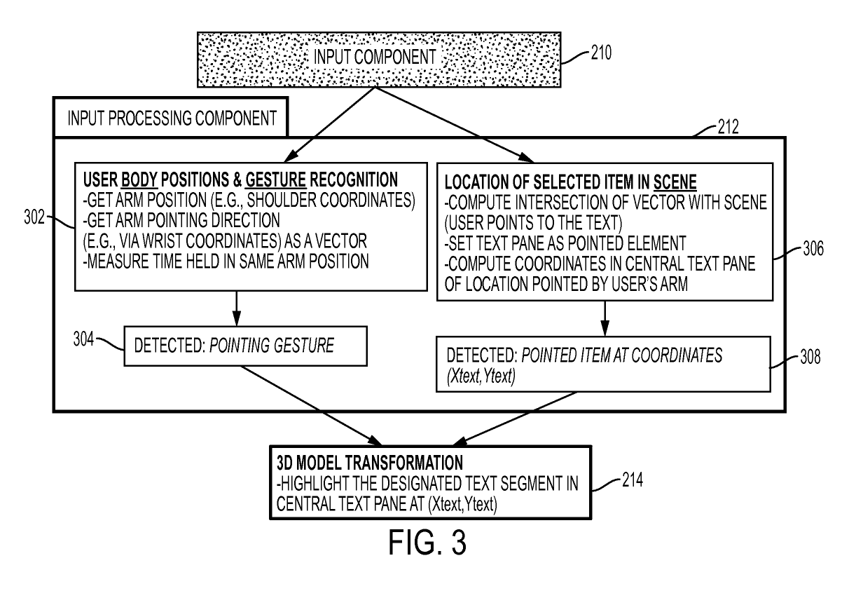

With reference to FIG. 3, shown is a block diagram of the Input Processing Component 212 shown in FIG. 2 associated with an exemplary example of a user interacting with a displayed document using a pointing gesture, where the user stretches their arm towards a displayed central text pane and the user points their arm to specific text to designate a text token.

To perform the pointing/highlighting function, the input processing component 212 performs a body position and gesture recognition process 302 to acquire arm position and arm pointing direction represented as a vector. In addition, the duration of time the user holds the same position is measured. Based on the data obtained in process 302, process 304 provides the detected pointed gesture data to the 3D model transformation process 214.

In addition to the execution of processes 302 and 304 to detect the appropriate pointing gesture, being executed concurrently is a process associated with the location of the user selected item in the scene 306 and detection of the selected item 308 including the coordinates of the text, i.e. (X text, Y text). Process 306 computes an intersection of a vector representative of the user's arm position and pointing direction with the scene displayed in the central pane. This computed intersection provides the text selected by the user and the process 306 computes the coordinates of the selected text relative to the central text pane. Process 308 provides the detected text item to the 3D model transformation process 214.

The 3D model transformation process 214 highlights the designated text segment in the central text pane at (X text, Y text).

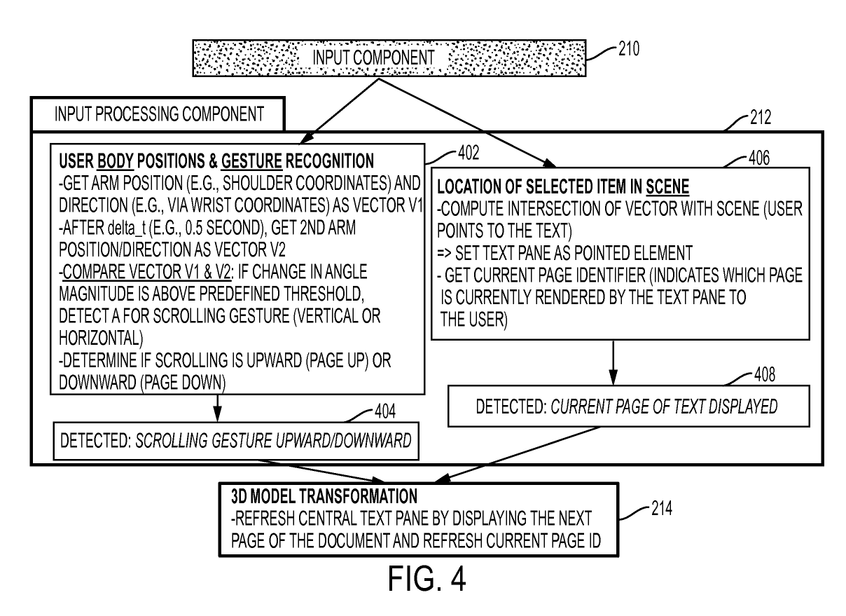

With reference to FIG. 4, shown is a block diagram of the Input Processing Component 212 shown in FIG. 2 associated with another exemplary example of a user interacting with a displayed document using a scrolling gesture, where the user stretches their arm towards the central text pane and moves it vertically towards a text pane to scroll up/down the text for reading page by page.

To perform the scrolling function, the input processing component 212 performs a body position and gesture recognition process 402 which initially acquires the user's first arm position and direction represented as a vector V1. Next, after as time interval delta-t the process 402 acquires the user's second arm position and direction represented as a vector V2.

Next, vectors V1 and V2 are compared to determine if a change in angle magnitude is above a predefined threshold, indicating a scrolling gesture.

Next, the process 402 determines if the scrolling is upward (page up) or downward (page down).

Process 404 provides a detected scrolling gesture and associated direction to the 3D model transformation process 214.

In addition to the execution of processes 402 and 404 to detect a user scrolling gesture, being executed concurrently is a process associated with the location of the user selected item in the scene 406 which determines the current page of text displayed and process 408 provides the page identifier to the 3D model transformation process 214.

3D model transformation process 214 refreshes the central text pane by displaying the next page of the document and refreshes the current page identifier.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

A machine-readable medium includes any mechanism for storing or transmitting information in a form readable by a machine (e.g., a computer). For instance, a machine-readable medium includes read only memory (“ROM”); random access memory (“RAM”); magnetic disk storage media; optical storage media; flash memory devices; and electrical, optical, acoustical or other form of propagated signals (e.g., carrier waves, infrared signals, digital signals, etc.), just to mention a few examples.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A computer-implemented method of displaying to a user a document and associated textual content within a 3D (Dimensional) Virtual Environment (VE) system and providing the user with an ability to directly interact with the document and associated textual content displayed within the VE system, the VE system including a Virtual Reality (VR) head-mounted display, one or more operatively associated arm gesture sensors, one or more operatively associated hand gesture sensors and one or more operatively associated controllers, the method comprising:
the VR head-mounted display displaying to a user a rendering of the document in a first vertical pane and displaying a second vertical pane, the rendering of the document including textual objects displayed on the first vertical pane and the second vertical pane configured to display one or more other objects associated with the textual objects, the textual objects displayed only on the first vertical pane and the other objects displayed only on the second vertical pane; and
the one or more controllers processing data received from the one or more arm gesture sensors and hand gesture sensors to select one of the textual objects displayed on the first vertical pane, and the one or more controllers processing the selected textual object to display on the second vertical pane associated with the VR head-mounted display the one or more other objects associated with the selected textual object, the one or more other objects including one or more of a video file, image file, audio file, 3D model files, and text meta-data.

2. (canceled)

3. The computer-implemented method according to claim 1, further comprising: one or more of a finger motion sensor and a head movement tracker operatively associated with the VR head-mounted display.

4. The computer-implemented method according to claim 1, further comprising the one or more controllers processing data received from the one or more arm gesture sensors and the one or more hand gesture sensors to generate a dynamically updated VE model including the first vertical pane and the second vertical pane, the one or more processors communicating the VE model to the VR head-mounted display, and the VR head-mounted display displaying a 3D (Dimensional) rendering of the dynamically updated VE model to the user.

5. The computer-implemented method according to claim 4, wherein the VE model is a 3D model, the first vertical pane is a central pane and the second vertical pane is a right viewable pane.

6. The computer-implemented method according to claim 5, wherein the VE model includes a third vertical pane which is a left viewable pane.

7. The computer-implemented method according to claim 6, further comprising:
the one or more controllers processing the selected textual object to display on the left viewable pane the selected textual object.

8. The computer-implemented method of displaying and directly interacting with documents according to claim 1, further comprising:
the one or more controllers extracting textual content from the document and processing the extracted textual content to control one or more of ambient luminosity and color of one or more of the first vertical pane, the second vertical pane, and a full VE model/scene.

9. An image processing system comprising memory storing instructions for performing the method according to claim 1.

10. A computer program product comprising a non-transitory recording medium encoding instructions which, when executed by a computer, perform the method of claim 1.

11. A document processing system for displaying to a user a document and associated textual content within a 3D (Dimensional) Virtual Environment (VE), and providing the user with an ability to directly interact with the document and associated textual content displayed within the VE, the document processing system comprising:
a Virtual Reality (VR) head-mounted display configured to display a virtual rendering of the document including a first vertical pane and a second vertical pane;
one or more operatively associated arm gesture sensors;
one or more operatively associated hand gesture sensors; and
one or more operatively associated controllers, the one or more controllers configured to:
generate a 3D model of the virtual rendering of the document and communicate the 3D model to the VR head-mounted display for viewing by the user, the 3D model including the first vertical pane and the second vertical pane, and the document including textual objects displayed on the first vertical pane and one or more other objects associated with the textual objects which are only displayed on the second vertical pane; and
process data received from the one or more arm gesture sensors and the one or more hand gesture sensors to select a textual object displayed on the first vertical pane and display on the second vertical pane the one or more other objects associated with the selected textual object, the one or more other objects including one or more of a video file, image file, audio file, and text meta-data and 3D model files.

12. (canceled)

13. The document processing system according to claim 11, further comprising: one or more of a finger motion sensor and a head movement tracker operatively associated with the VR head-mounted display.

14. The document processing system according to claim 11, wherein the VE model is a 3D (Dimensional) model, the first vertical pane is a central pane and the second vertical pane is a right viewable pane.

15. The document processing system according to claim 14, wherein the VE model includes a third vertical pane which is a left viewable pane.

16. The document processing system according to claim 15, the one or more controllers configured to display on the left viewable pane the selected textual object.

17. The document processing system according to claim 11, wherein the one or more controllers are configured to extract textual content from the document to control one or more of ambient luminosity and color of one or more of the first vertical pane, the second vertical pane, and a full VE model/scene.

18. A document processing system for displaying to a user a document and associated textual content within a Virtual Environment (VE) and providing the user with an ability to directly interact with the document and associated textual content displayed within the VE system, the document processing system comprising:
a Virtual Reality (VR) head-mounted display configured to display a 3D (Dimensional) virtual rendering of a document including textual objects in a first active vertical pane and one or more other objects in a second active vertical pane and one or more user selected textual objects in a third active vertical pane, the textual objects displayed only on one or both of the first and third active vertical panes and the other objects only displayed in the second active vertical pane, the other objects including one or more of a video file, image file, audio file, text meta-data, and 3D model files;
an arm gesture sensor;
a hand and finger motion sensor;
a model transformation module configured to operatively receive gesture data from the VR head-mounted display, arm gesture sensor and, hand and finger motion sensor to select one of the textual objects displayed in the first active vertical pane and, and the model transformation module configured to process the received gesture data and generate 3D model transformations formatted to be communicated to a VE (Virtual Environment) rendering module; and
the VE rendering module configured to receive the model transformation, generate an active VR model associated with active scenes to be rendered by the VR head-mounted display, and communicating the active scenes to the VR head-mounted display for rendering, the active scenes including the first active vertical pane, the second active vertical pane and the third active vertical pane.

19. (canceled)

20. (canceled)
